(19) United States
(12) Patent Application Publication
(10) Pub. No.: US 2012/0192670 A1
(43) Pub. Date: Aug. 2, 2012

(54) OPERATION DEVICE OF SHIFT MECHANISM IN MANUAL TRANSMISSION

(75) Inventors: Isao MIZUTANI, Nukata-gun (JP); Arisa Himeno, Nishio-shi (JP)

(73) Assignee: AISIN AI CO., LTD., Nishio-shi (JP)

(21) Appl. No.: 13/358,849

(22) Filed: Jan. 26, 2012

(30) Foreign Application Priority Data
Jan. 27, 2011 (JP) 2011-015634

(51) Int. Cl. G05G 5/05

(52) U.S. Cl. 74/473.21

(57) ABSTRACT

An operation device of a shift mechanism in a manual transmission includes a cylindrical support member fixedly mounted within the transmission housing in such a manner that a radial projection on an operation shaft of the shift mechanism is concentrically placed in the cylindrical support member and a leaf spring having a central portion formed with a V-shaped concave to be engaged with the radial projection of the operation shaft and a pair of side portions fixed to opposite ends of the cylindrical support member such that the V-shaped concave is maintained in engagement with the radial projection to retain the operation shaft in a neutral position, whereby load of the leaf spring acting on the operation shaft respectively when shifted in one direction and in the other direction can be adjusted in different characteristics.

### BACKGROUND OF THE INVENTION

1. Field of the Invention

The present invention relates to an operation device of a gearshift mechanism in a manual transmission and, more particularly to an operation device capable of adjusting load characteristics of operation stroke in a shift-and-select mechanism.

2. Description of the Prior Art

Disclosed in Japanese Patent Laid-open Publication No. 2004-100741 is a manual transmission which includes a plurality of change-speed gear pairs provided between an output shaft and a counter shaft mounted in parallel within a transmission housing and a shift-and-select mechanism for selectively operating a plurality of gear-shift mechanisms provided between the change-speed gear pairs, wherein the change-speed gear pairs are selectively engaged by operation of the shift-and-select mechanism to establish a drive power train.

As shown in FIG. 8, the shift-and-select mechanism in the manual transmission includes three fork shafts 4 mounted in parallel within a transmission housing 1 for axial movement (one of the fork shafts is shown in the figure), a shift-and-select shaft 2 supported perpendicularly across the fork shaft 4 in the housing for axial and rotational movements, and an inner lever 3 splined to the shift-and-select shaft 2 for rotation therewith. A projection 3a of inner lever 3 is brought into engagement with a recess of a shift piece 4a fixed to the fork shaft 4 when moved in an axial direction. When the inner lever 3 is rotated with the shift-and-select shaft 2, the fork shaft 4 is shifted by the projection 3a of inner lever 3 in engagement with the shift piece 4a to selectively operate the gear-shift mechanisms of the change-speed gear pairs. The inner lever 3 is formed at its upper end periphery with a V-shaped recess and triangular cam surfaces 3b at opposite sides of the recess. A spring loaded detent mechanism 5 is provided to retain the inner lever 3 by engagement with the cam surfaces 3b in a rotated position. The detent mechanism 5 includes a cylindrical case 6 threaded into an internal wall of the housing 1 perpendicularly across the axis of shift-and-select shaft 2, a slide element 7 supported in the cylindrical case 6 for axial movement and loaded by a spring 9 toward the inner lever 3, and a ball 8 rotatable in a concaved spherical surface formed in the slide element 7 through a large number of spaced small balls. A detent mechanism (not shown) similar to the detent mechanism 5 is provided to retain the other shift-and-select shafts 2 respectively in a shifted position.

Illustrated in FIG. 9 is load characteristic in shift stroke of a change-speed lever. When the change-speed lever is shifted forward to bring one of the change-speed gear pairs into engagement with the output shaft in a neutral condition where the ball 8 of detent mechanism 5 is retained in engagement with the cam surfaces of the V-shaped recess of inner lever 3 as shown in FIG. 8, the inner lever 3 is rotated in a direction corresponding with the shift direction so that the ball 8 is pushed up by engagement with one of the cam surfaces against the biasing force of spring 9. In such an instance, the load necessary for shifting the change-speed lever increases in accordance with increase of the shift stroke of the change-speed lever as shown by an arrow C along a stroke load characteristic curve Q in FIG. 9. The load for shifting decreases before the ball 8 reaches an apex of the V-shaped recess and becomes zero when the ball 8 reaches the apex of the V-shaped recess. When the ball 8 rides over the apex of the V-shaped recess, the load for shifting becomes a negative value. In a position where the negative value increases and decreases, the inner lever 3 is arrested by abutment with a stopper (not shown). When the change-speed lever is shifted in a return direction to disengage the change-speed gear pair from the output shaft in a condition where the inner lever 3 is retained in abutment with the stopper, the inner lever 3 is rotated in a reverse direction so that the ball 8 of detent mechanism moves in a reverse direction on the cam surface 3b. In such an instance, the load necessary for shifting the change-speed lever changes in a reverse direction as shown by an arrow D along the stroke load characteristic curve Q.

In the shift-and-select mechanism shown in FIG. 8, the shift-and-select shaft 2 is selectively connected with the fork shafts 4 when shifted in an axial direction, and the connected fork shaft 4 is shifted by rotation of the shift-and-select shaft 2 in an axial direction. In a conventional shift-and-select mechanism disclosed in Japanese Patent Laid-open Publication No. 2004-108468, the connection with the fork shaft 4 is selected by rotation of the shift-and-select shaft 2, and the fork shaft 4 is moved in an axial direction for changing over the change-speed gear pair when the shift-and-select shaft 2 is moved in an axial direction.

In a shift-and-select mechanism shown in FIG. 10, an inner lever 12 is splined to a select shaft 11 mounted within a transmission housing 10 for rotational movement and fixed in place by means of a spring pin 17. The inner lever 12 has a projection 12a in engagement with a select member 13 similar to the shift piece 4a shown in FIG. 8 and an arm portion 12b formed with a curved cam surface 12c. A detent mechanism 14 is provided to retain the inner lever 12 in a rotated position by engagement with the cam surface 12c of arm portion 12b. The detent mechanism 14 includes a leaf spring 15 bolted to an internal wall of housing 10 and a roller 16 supported on a distal end of leaf spring 15 by means of a pivot pin 16a in parallel with the select shaft 11, wherein the roller 16 is resiliently pressed to the cam surface 12c under load of leaf spring 15. In the shift-and-select mechanism shown in FIG. 10, the select mechanism is separated from the shift mechanism since the select shaft 11 does not displace in an axial direction.

As the shift mechanism and the select mechanism in the manual transmission shown in FIG. 8 are united in assembly, the number of component parts can be reduced and assembled in a small space. It is advantageous that both the inclined surfaces of the V-shaped recess for forming the cam surfaces of the inner lever can be angularly changed for adjusting the shift feeling of the change-speed lever. It is, however, difficult to arcuate each inclined cam surface for adjustment of the shift feeling since the inclined cam surfaces 3b are short in length in comparison with the diameter of ball 8. It is also difficult to effect load characteristics different in forward and backward shifting operations for adjustment of the shift feeling.

### SUMMARY OF THE INVENTION

An object of the present invention is to provide an operation device of a shift mechanism united with a select mechanism capable of effecting load characteristics different in forward and backward shifting operations for adjustment of the shift feeling.

According to the present invention, the object is accomplished by providing an operation device of a shift mechanism in a manual transmission which includes a plurality of change-speed gear pairs provided between an output shaft and a counter shaft mounted in parallel within a transmission housing and a shift mechanism for selectively operating a plurality of gear-shift mechanisms respectively provided between the change-speed gear pairs, wherein the operation device of the shift mechanism comprises a cylindrical support member fixedly mounted within the transmission housing in such a manner that a radial projection on an operation shaft of the shift mechanism is concentrically placed in the cylindrical support member and a leaf spring having a central portion formed with a V-shaped concave to be engaged with the radial projection of the operation shaft and a pair of parallel side portions fixed to opposite ends of the cylindrical support member such that the V-shaped concave is maintained in engagement with the radial projection to retain the operation shaft in a neutral position, whereby load of the leaf spring acting on the operation shaft respectively when shifted in one direction and in the other direction can be adjusted in different characteristics.

In the operation device of the shift mechanism described above, an axial component of a pushing force of the radial projection acting on the central portion of the leaf spring causes the operation shaft to displace in a stroke direction. The displacement of the operation shaft in the direction of backward stroke from the shift end position to the neutral position will occur in reverse to that in the direction of forward stroke from the neutral position to the shift end position. Accordingly, the load characteristic of the leaf spring in the forward stroke is deviated outward, while the load characteristic of the leaf spring in the backward stroke is deviated inward. As a result, the load characteristics of the leaf spring acting on the operation shaft can be adjusted to be different in forward shift and backward shift of the operation shaft.

In a practical embodiment of the present invention, a plurality of leaf springs each formed with a V-shaped concave and fixed at their side portions to opposite ends of the cylindrical support member are symmetrically arranged in such a manner that the radial projection of the operation shaft is enclosed by the V-shaped concaves of the leaf springs. In such an embodiment, biasing forces of the leaf springs radially inwardly acting on the operation shaft are balanced without causing any arcuation of the operation shaft for smooth shift operation.

As in the operation device of the present invention, the operation shaft with the radial projection is axially displaceable and rotatable with respect to the leaf spring, the operation shaft can be utilized as a single shift-and-select shaft to provide a select mechanism united with a shift mechanism to reduce the number of component parts.

In the case that the radial projection of the operation shaft is in the form of a rotary element or a roller in engagement with the leaf spring, frictional coefficient between the radial projection and the leaf spring decreases. Accordingly, an inclined angle of a portion of the leaf spring in contact with the radial projection of the operation shaft may be increased for expanding the extent for adjustment of the load characteristics in shift stroke of the operation shaft.

### BRIEF DESCRIPTION OF THE DRAWINGS

In the drawings;

FIG. 1 is a sectional view of an operation device of a shift mechanism in a manual transmission in accordance with the present invention;

FIG. 2 is a right-side view of the operation device shown in FIG. 1;

FIG. 3 illustrates action of leaf springs in forward stroke of an operation shaft shown in FIG. 1;

FIG. 4 illustrates action of the leaf springs in backward stroke of the operation shaft;

FIG. 5 is a graph showing load characteristics in shift stroke of the operation shaft shown in FIG. 1;

FIG. 6 depicts a modification of the operation shaft shown in FIG. 1;

FIG. 7 depicts another modification of the operation shaft shown in FIG. 1;

FIG. 8 is a sectional view of a shift-and-select mechanism in a conventional manual transmission;

FIG. 9 is a graph showing load characteristic in shift stroke of the shift-and-select mechanism shown in FIG. 8; and

FIG. 10 is a sectional view of another shift-and-select mechanism in a conventional manual transmission.

### DESCRIPTION OF PREFERRED EMBODIMENTS

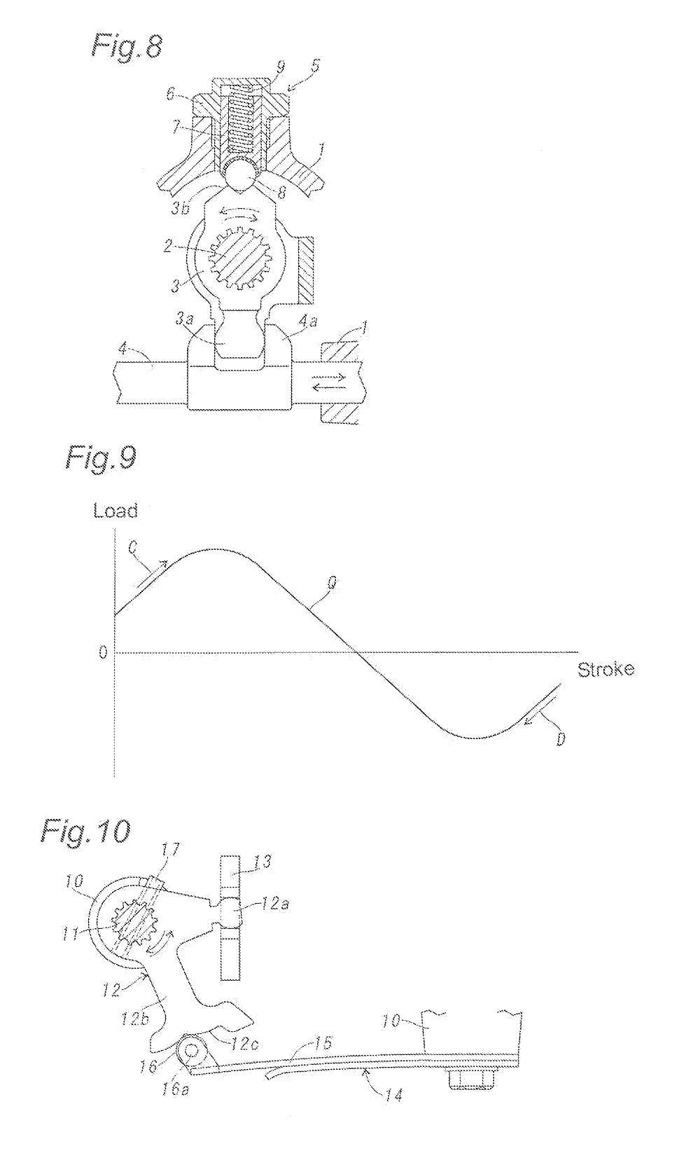

The present invention is adapted to an operation shaft of a shift mechanism to be axially shifted as a fork shaft in a shift-and-select mechanism shown in FIG. 8 or 10. Hereinafter, a preferred embodiment of the present invention will be described with reference to the drawings.

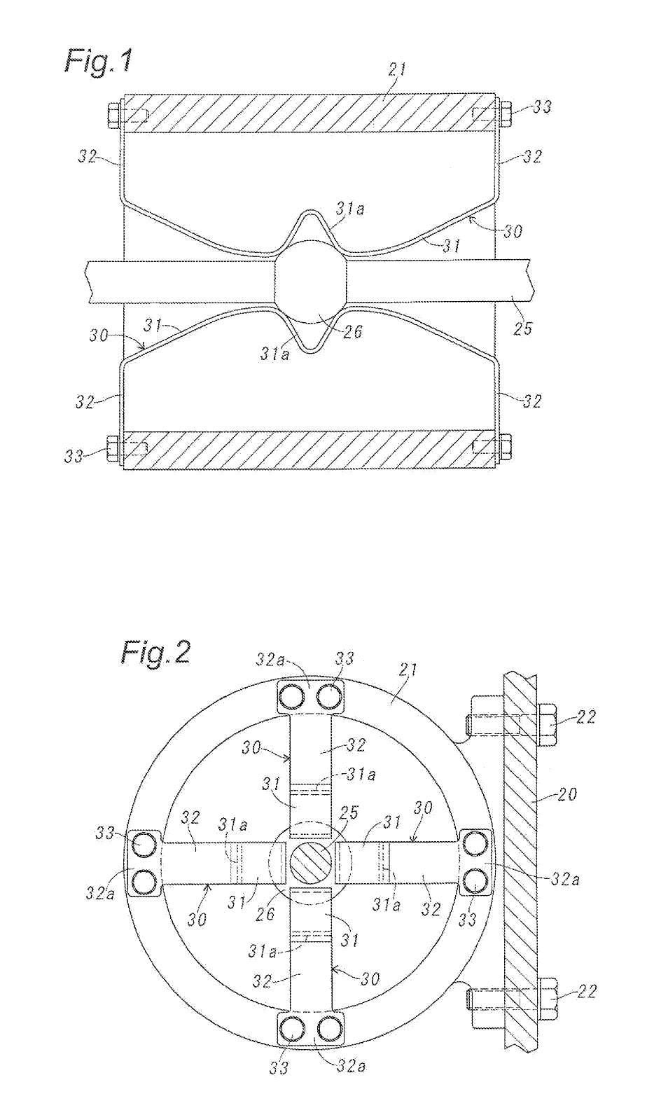

As shown in FIGS. 1 and 2, an operation shaft 25 axially movable in a shift mechanism is formed thereon with a radial projection 26 having a spherical surface. A cylindrical support member 21 is fixedly mounted within a transmission housing and placed concentrically with the operation shaft 25. Four leaf springs 30 enclosing the radial projection 26 of operation shaft 25 are symmetrically arranged in engagement with the spherical surface of radial projection 26. The leaf springs 30 each are made of steel and have a central portion 31 formed with a V-shaped concave 31a to be engaged with the radial projection 26 of operation shaft 25 and a pair of parallel side portions 32 fixed to opposite ends of the cylindrical support member 21 by means of fastening screws 33 such that the V-shaped concave 31a is maintained in resilient engagement with the radial projection 26. As shown in FIG. 2, the opposite ends of each spring 30 is in the form of T-shaped portion 32a fixed to an end surface of cylindrical support member 21. When a change-speed lever (not shown) of the manual transmission is placed in a neutral position, the spherical surface of radial projection 26 is maintained in engagement with the V-shaped concave 31a of each spring 30 to resiliently retain the operation shaft 25 in the neutral position.

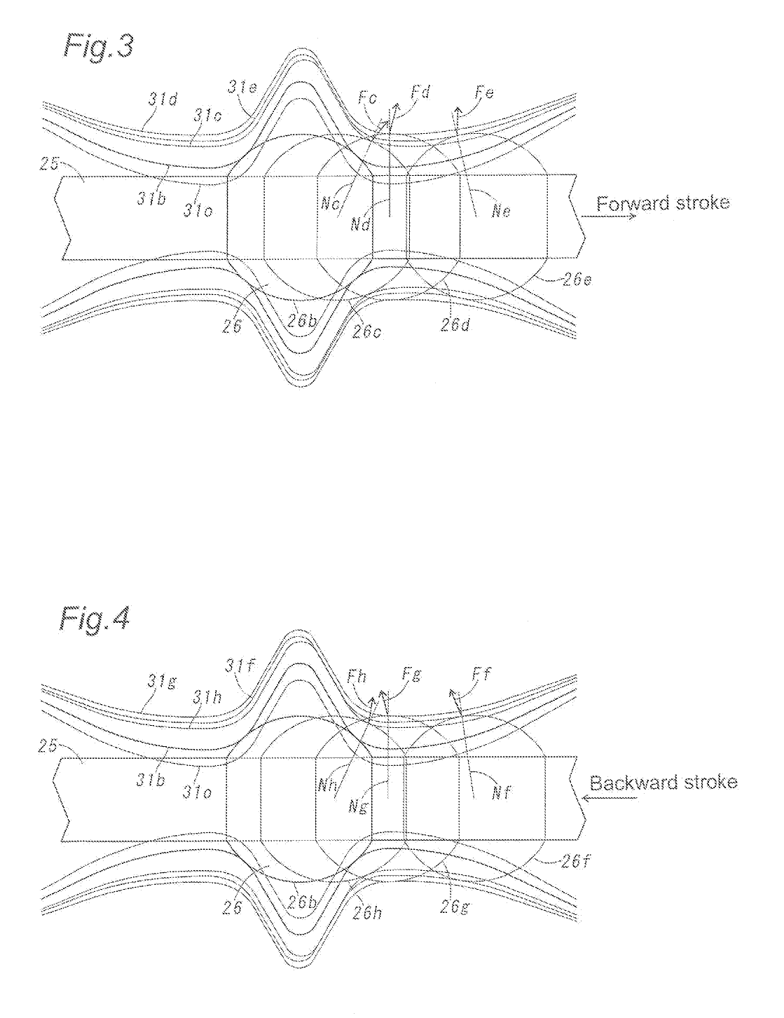

Illustrated in FIGS. 3 and 4 are movements of leaf springs 30 in shift stroke of the operation shaft. When the operation shaft 25 is in the neutral position, the V-shaped concave 31a of each leaf spring 30 is in engagement with the spherical surface of the projection 26 of operation shaft 30 in a position shown by the reference numeral 26b, and the leaf springs 30 are arcuated as shown by the reference numeral 31b. When the operation shaft 25 is shifted by operation of the change-speed lever rightward in an axial direction to cause displacement of the projection 26 to a position shown by the reference numeral 26c, the central portion of each leaf spring 30 is pushed up by the projection 26 of operation shaft 25. In such a condition, the V-shaped concave 31a of each leaf spring 30 is brought at one side thereof into engagement with the projection 26, a normal line Nc at the engagement point is inclined rightward with respect to a perpendicular line across the operation shaft 25, and a pushing force Fc of projection 26 acting on the central portion of each leaf spring 30 is inclined rightward with respect to the normal line Nc. This increases a component in the direction of shift stroke. As both the side portions 32 of each leaf spring 30 are flexed by the component, the central portion of each leaf spring 30 is raised and displaced rightward to a position of the reference numeral 31c. Thus, a counter force of the component in the direction of shift stroke is applied to the projection 26 of operation shaft 26 as load in an axial direction.

When the operation shaft 25 is further moved rightward to bring the apex of projection 26 into engagement with the central portion of each leaf spring 30 in a position shown by the reference numeral 26d, a normal line Nd at the engagement point crosses perpendicularly to the axial line of operation shaft 25. This decreases the rightward component of the pushing force Fd of projection 26 acting on the central portion 31 of each leaf spring 30. In such an instance, the central portion of each leaf spring 30 is displaced to a position shown by the reference numeral 31d. The displacement amount decreases less than that at the position 31c, resulting in decrease of the load applied to the operation shaft 25 in the axial direction. When the operation shaft 25 is further moved rightward to bring the projection 26 into engagement with an outside of the central portion of each leaf spring 30, a normal line Ne at the engagement point inclines leftward with respect to a perpendicular line across the axial line of operation shaft 15, and an axial component of the pushing force Fe of the projection 25 acting on each leaf spring 30 is directed leftward. In such an instance, the central portion of each leaf spring 30 approaches as shown by the reference numeral 31e more than at the position 31d and is displaced leftward. Thus, the load applied to the operation shaft 25 becomes a negative value from the positive value.

When the operation shaft 25 is further moved rightward, each leaf spring 30 further approaches the operation shaft 25 to direct the axial component of projection 26 acting on each leaf spring 30 further leftward thereby to displace the central portion of each leaf spring 30 further leftward. In such an instance, the central portion of each leaf spring 30 further approaches the operation shaft 25 and displaces further leftward from a position 31e. This decreases the negative load applied to the operation shaft 25 and causes the operation shaft 25 to arrest at a shift end position in abutment with a stopper. In this instance, each biasing force of leaf springs 30 acting on the projection 26 of operation shaft 25 is directed in the direction of normal line to retain the operation shaft 25 in the shift end position.

When the operation shaft 25 is moved by operation of the change-speed lever leftward from the shift end position as shown in FIG. 4, the projection 6 of operation shaft 25 moves leftward to push up the central portion of each leaf spring 30. In such an instance, the pushing forces Ff˜Fh of projection 26 acting on the central portion of each leaf spring 30 becomes a leftward inclined force with respect to normal lines Nf˜Nh. When the projection 26 reaches a position 26, an axial component of the pushing force Ff of projection 26 at a point in contact with the central portion of each leaf spring 30 increases, and the central portion of each leaf spring 30 is displaced leftward. As both the side portions 32 of each leaf spring 30 are flexed by the leftward component, the central portion of each leaf spring 30 is pushed up and displaced leftward to a position 31f. Thus, a counter force of the component in the stroke direction acts as axial load on the projection 26 of operation shaft 25.

When the operation shaft 25 is further shifted leftward to bring the apex of projection 26 into engagement with the central portion of each leaf spring 30 at a position 25g, a leftward component of the pushing force Fg of projection 26 acting on the central portion of each leaf spring 30 decreases after increased. This decreases an axial displacement amount of the central portion of each spring 30 as shown by the reference numeral 31g. When the operation shaft 25 is further shifted leftward to bring the projection 26 into engagement with an inside of the central portion of each leaf spring 30, the axial component of the pushing force of projection 26 acting on the central portion of each leaf spring 30 changes rightward from leftward, and the load applied to the operation shaft 25 becomes a negative value from the positive value. When the operation shaft 25 is further shifted leftward, the central portion of each leaf spring 30 rapidly approaches the operation shaft 25, the load applied to operation shaft 25 (a counter force of the axial component) decreases after increased in the negative value. Thus, the operation shaft 25 is arrested in the neutral position when the projection 26 is brought into engagement with the V-shaped concave 31a of each leaf spring 30.

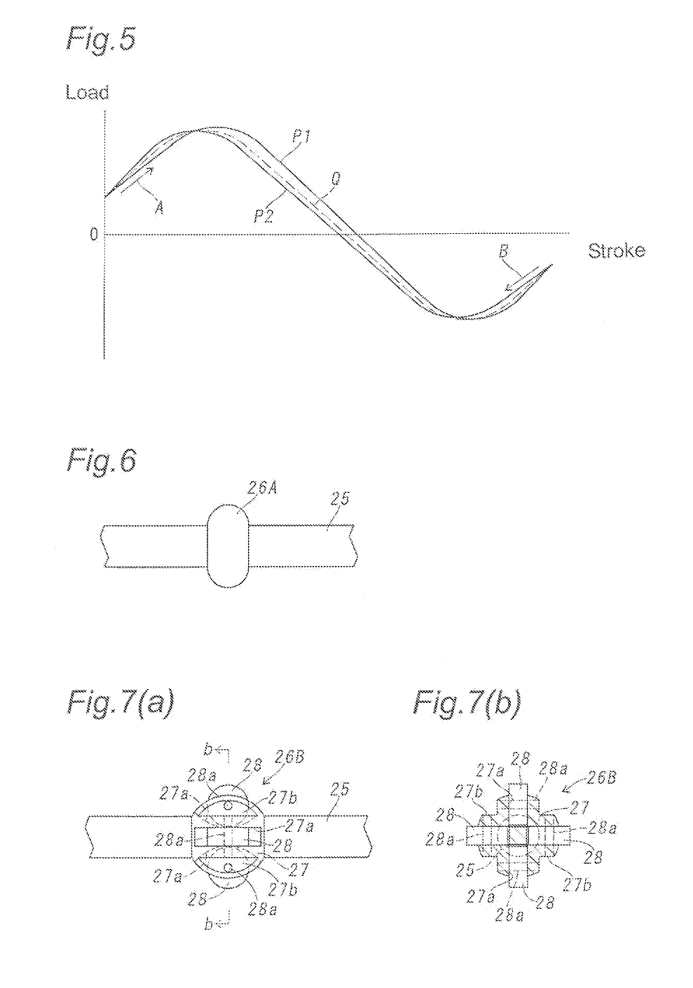

As is understood from the above description, the projection 26 of operation shaft 25 is retained in the neutral position by engagement with the V-shaped concave 31a of each leaf spring 30. When the operation shaft 25 is shifted forward or outward from the neutral position to the shift end position, the stroke load applied to the operation shaft 25 decreases after increased and decreases after increased in the negative value. When the operation shaft 25 is shifted backward or inward from the shift end position to the neutral position, the stroke load applied to the operation shaft 25 decreases after increased and decreases after increased in the negative value. Such increase and decrease of the stroke load is the same as the characteristic of the stroke load in the prior art shown in FIG. 9. In the foregoing embodiment, however, the axial component of the pushing forces Fc˜Fh of the projection 26 acting on the central portion 31 of each leaf spring 30 causes the operation shaft 25 to displace in the stroke direction. The displacement of the operation shaft 25 in the direction of backward stroke from the shift end position to the neutral position will occur in reverse to that in the direction of forward stroke from the neutral position to the shift end position. Accordingly, the load of leaf springs 30 in forward stroke is displaced rightward from the characteristic Q of stroke load in the prior art as shown by the reference character P1 in FIG. 5, while the load of leaf springs 30 in backward stroke is displaced leftward from the characteristic of stroke load in the prior art as shown by the reference character P2 in FIG. 5. As a result, the load characteristics of the leaf springs 30 acting on the operation shaft can be adjusted to be different in forward stroke and backward stroke of the operation shaft 25. The adjustment of the stroke load can be effected by variation of the length of side portions of leaf springs 30, the thickness of leaf springs 30 or the inclined angle of V-shaped concave 31a.

In FIG. 6, there is disclosed another embodiment of the present invention wherein the operation shaft 25 is provided with an annular projection 26A having an arcuate outer surface. The annular projection 26A is arranged to be engaged at its both sides with each V-shaped concave 31a of the four leaf springs 30 as in the embodiment shown in FIG. 1. In the embodiments described above, the operation shaft 25 with the projection 26 or 26A is axially displaceable and rotatable with respect to the leaf springs 30. Thus, the operation shaft 25 can be utilized as a single shift-and-select shaft to provide a select mechanism united with a shift mechanism thereby to reduce the number of component parts.

The spherical projection 26 of operation shaft 25 may be replaced with a projection 27 shown in FIGS. 7(a), 7(b). The projection 27 is formed with four circumferentially spaced axial grooves 27a, and a roller 28 is arranged in each axial groove 27a and pivoted on the operation shaft 25 for rotation by means of a pivot pin 28a. The projection 27 is also formed thereon with notches 27b. Each roller 28 pivoted on the operation shaft 25 is arranged to be rotated by engagement with the V-shaped concaves 31a of the four leaf springs 30 as in the embodiment shown in FIG. 1. As in this embodiment, frictional coefficient between the rollers 28 and leaf springs 30 is reduced, the extent for adjustment of load characteristics in shift stroke of the operation shaft 25 can be broaden by increase of an inclined angle at the central portion of each leaf spring 30 for engagement with the rollers 28.

As the plurality of leaf springs 30 in the foregoing embodiments are symmetrically arranged to enclose the projection 26, 26A or 27 of the operation shaft 25, resilient forces of the leaf springs 30 radially inwardly acting on the operation shaft are balanced without causing any arcuation of the operation shaft for smooth shift operation.

What is claimed is:

1. An operation device of a shift mechanism in a manual transmission which includes a plurality of change-speed gear pairs provided between an output shaft and a counter shaft mounted in parallel within a transmission housing and a shift mechanism for selectively operating a plurality of gear-shift mechanisms respectively provided between the change-speed gear pairs, wherein the operation device of the shift mechanism comprises a cylindrical support member fixedly mounted within the transmission housing in such a manner that a radial projection on an operation shaft of the shift mechanism is concentrically placed in the cylindrical support member and a leaf spring having a central portion formed with a V-shaped concave to be engaged with the radial projection of the operation shaft and a pair of side portions fixed to opposite ends of the cylindrical support member such that the V-shaped concave is maintained in engagement with the radial projection to retain the operation shaft in a neutral position, whereby load of the leaf spring acting on the operation shaft respectively when shifted in one direction and in the other direction can be adjusted in different characteristics.

2. An operation device of a shift mechanism in a manual transmission which includes a plurality of change-speed gear pairs provided between an output shaft and a counter shaft mounted in parallel within a transmission housing and a shift mechanism for selectively operating a plurality of gear-shift mechanisms respectively provided between the change-speed gear pairs, wherein the operation device of the shift mechanism comprises a cylindrical support member fixedly mounted within the transmission housing in such a manner that a radial projection on an operation shaft of the shift mechanism is concentrically placed in the cylindrical support member and a plurality of leaf springs each having a central portion formed with a V-shaped concave to be engaged with the radial projection of the operation shaft and a pair of side portions fixed to opposite ends of the cylindrical support member, the leaf springs being symmetrically arranged in such a manner that the radial projection of the operation shaft is enclosed by the V-shaped concaves and maintained in engagement therewith to retain the operation shaft in a neutral position, whereby load of the leaf springs acting on the operation shaft respectively when shifted in one direction and in the other direction can be adjusted in different characteristics.

3. An operation device of a shift mechanism in a manual transmission as claimed in claim 1, wherein the radial projection of the operation shaft is in the form of a spherical body.

4. An operation device of a shift mechanism in a manual transmission as claimed in claim 1, wherein the radial projection of the operation shaft is in the form of a rotary element rotatable in engagement with the leaf spring.

5. An operation device of a shift mechanism in a manual transmission as claimed in claim 1, wherein the radial projection of the operation shaft is in the form of a roller pivoted on the operation shaft for rotation in engagement with the leaf spring.
